(19) United States
(12) Patent Application Publication
(10) Pub. No.: US 2001/0049826 A1
(43) Pub. Date: Dec. 6, 2001

(54) Method of searching video channels by content

(76) Inventor: Itzhak Wilf, Neve Monoson (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/761,817

(22) Filed: Jan. 18, 2001

Related U.S. Application Data
(60) Provisional application No. 60/176,820, filed on Jan. 19, 2000.

(51) Int. Cl. H04N 7/173

(52) U.S. Cl. 725/120

(57) ABSTRACT

A method for selecting a channel of interest from a plurality of communication channels which carry audio or video information, by: extracting image or sound characteristic data from said audio or video information, searching for specific content of interest based on said image or sound characteristic data and selecting a channel based on said content of interest is described. Image and sound characteristic data are stored on a content-based channel search server, which includes video search engines capable of matching attributes related to user interest profiles with data corresponding to current content of multiple channels. User interact with the server via client terminals, which communicate with the server using the Internet protocol. Client terminal receive search results corresponding to matches between channel content and user profile. The client terminal controls a variety of viewing, recording and logging devices.

### FIELD AND BACKGROUND OF THE INVENTION

The present invention relates to multi-channel video/television systems and, in particular, to a method of providing viewers with automated selection of channels which match viewer's defined search criteria.

The number of video channels available over cable television systems and satellite television systems increases rapidly. Therefore, users need improved methods for selecting video channels that at a given time carry a preferred program and or content. Similar needs occur in video on demand systems, interactive television, and certain internet-television arrangements.

For years, viewers have relied on pre-printed television program listing. There are numerous disadvantages in using an external paper-based information source, which is updated usually once a week.

In recent years, television-based electronic program guides (EPG) have been developed. Program listing are displayed directly on the TV screen and provide better access and ease of updating as compared to pre-printed guides. Typically, the EPG is a scrolling TV program list that is transmitted over a dedicated cable channel. Viewers can tune to the guide channel and view information about programs being then transmitted or to be transmitted in the near future.

Another form of dedicated cable channel contains a split screen display of the other channels. A video combination device generates the display such that several video channels (say 16) are displayed concurrently. When the number of channels is greater than the capacity of a single display screen, several displays are time-toggled to cover the entire set of channels. However, the passive nature of this technique limits its value. Also, one cannot search by title, genre, channel or view listing for programs scheduled a few days ahead.

Several prior art methods are specifically directed to channel searching. For example, advanced EPG methods provide graphics overlays, menus and interactive search by title, subject, time and channel.

In some prior art methods, the search capabilities are manual and therefore disturb the viewing habit. Also, manual techniques are very limited in situations of hundreds of video channels.

In other prior art methods, automatic searching is based on pre-encoded textual descriptions of the video content. Such descriptions are subjective and usually very concise, Closed captions, which are encoded into the video signal, contain a transcription of the dialogues but do not relate to any visual information. Additionally, no provision is made for events that are happening in real time such as a sudden or dramatic event that is as “breaking news”. Such event is probably not contained in the EPG data.

More specifically, in some prior art methods, a signal processing unit is provided with one or more analyzing units to analyze textual information decoded from a number of channels of a communication signal to determine if channel contents of the channels are among channel contents defined by selection data. The signal-processing unit is further provided with an arbitrating unit for arbitrating display and/or recording resource contentions among channels having channel contents defined by selection data.

The Internet is an international network based on various standard protocols and transfer mechanisms, which supports thousands of computer networks. The basic transfer protocol used by the Internet is referred to as TCP/IP (Transfer Control Protocol/Internet Protocol). The Internet essentially provides an interactive image and document presentation system which enables users to selectively access desired information and/or graphics content. The Internet has grown to form an information superhighway or information backbone with many and varied commercial uses.

The Internet includes various server types, including World Wide Web (WWW) servers, which offer hypertext capabilities. Hypertext capabilities allow the Internet to link together a web of documents, which can be navigated using a convenient graphical user interface (GUI). WWW servers use Uniform Resource Locators (URLs) to identify documents, where a URL is the address of the document that is to be retrieved from a network server. The WWW, also referred to as the “web”, also uses a hypertext language referred to as the hypertext mark-up language (HTML). HTML is a scripting or programming language, which allows content providers or developers to place hyperlinks within web pages which link related content or data. The web also uses a transfer protocol referred to as the HyperText Transfer Protocol (HTTP). When a user clicks on a link in a web document, the link icon in the document contains the URL, which the client employs to initiate the session with the server storing the linked document. HTTP is the protocol used to support the information transfer.

In the early days of the Internet, web sites featured only text and still images content. Since audio and video files are much larger than text or graphics, it would have taken an unacceptably long time to download them on slow dial-up connections, which were used by most Internet surfers. Recent bandwidth and technology improvements have made Internet multimedia more viable for everyday use. Inexpensive cable modems, xDSL modems and direct broadcast satellite (DBS) dishes bring high-speed Internet access into homes and offices, thus eliminating bandwidth constraints. The new concept of streaming media minimizes the download time of audio and video contents from the Internet. “Streaming” enables a software player to begin playback of a multimedia file before it is fully downloaded. The file is sent directly to the playback mechanism, without being written to the hard drive. Streaming video encoders, servers and players are available from companies such as Real Networks (www.realnetworks.com) and Microsoft.

Many sites on the Internet such as www.fastv.com, www.videoseeker.com aggregate a selection of current and archived video content from news, information and entertainment sources. Text search and key-frame browsing techniques are employed by such sites to facilitate finding a clip of interest, or a portion of a clip. Clips and current programs may also be organized in channel tabs such as News, Sports, Business, Entertainment and Lifestyle.

Several sites on the Internet provide TV program schedules. For example, in a web site www.tvguide.com the user enters his or her Zip code for local cable TV listings, satellite provider and time zone for satellite TV listings or time zone for national network lineups. The user may search by category such as action, children, comedy, drama, educational, family, movie, mystery, news, SciFi, sports, soap.

There are several embodiments in prior art to combine a television and an Internet display. A commercially available system has been proposed by Sony named the WebTV Internet Terminal, and is designed to work with televisions that have Picture-In-Picture (PIP) capability. A viewer can watch the television broadcast signal in the Picture-In-Picture while the user is browsing the Web, and enlarge the television signal when something of interest appears on the television signal. The WebTV Plus service offers features that help the user find TV shows of interest and watch 7 days of on-screen interactive television listings. Television listings search by category or keyword for the desired is supported.

Other proposed solutions for integrating the Internet with television involve altering the television itself, by providing an “interactive” television with built-in Web browsing capability. These television sets, proposed by Zenith Electronics, include a 28.8 Kbps modem and an Ethernet port. Another system, proposed by Gateway 2000, is an actual computer with television viewing capability.

There exists a need for an improved television channel selection method, which employs automatic searching in video, based on the audio and video content of the television channels. There exists also a need for the method to match the viewer's preferences, specified as a query, with the content attributes of the television channels which are extracted automatically and in real-time from these channels.

### BRIEF SUMMARY OF THE INVENTION

According to one aspect of the present invention, there is provided a method of selecting a channel of interest from a plurality of communication channels which carry audio or video information, comprising extracting image or sound characteristic data from said audio or video information; searching for specific content of interest based on said image or sound characteristic data and selecting a channel based on said content of interest.

According to another aspect of the present invention, there is provided a method of tuning to a channel of interest from a plurality of broadcast signals received by receiver device, using an Internet-enabled computing device, comprising: creating a correspondence between broadcast channel signals received by said receiver device and channel characteristic data stored on at least one Internet site; and searching for specific content of interest based on said channel characteristic data; and selecting a channel based on said content of interest; and tuning said receiver device to said selected channel.

In one described preferred embodiment, the content that is searched and detected may be stored in a recording device, enabling future viewing and programs/events statistics information gathering. In another described preferred embodiment, the data processor at the remote location generates indexing data that is stored in a web server in the Internet.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a block diagram showing an overview of several embodiments according to the present invention.

FIG. 2 presents one preferred embodiment according to the present invention.

FIG. 3 describes an automatic channel content analysis engine according to the present invention.

FIG. 4 described a preferred embodiment for a content-based video search server.

FIG. 5 presents a graphical interface for creating user's queries, according to the present invention.

FIG. 6 presents a graphical interface for selecting people as part of a user profile.

FIG. 7 presents a graphical interface for entering face images of specific people as new query items.

FIG. 8 presents user options in setting communication and player capabilities for a search client.

FIG. 9 presents flow of change channel client actions.

FIG. 10 presents menu structure for establishing connections with content-based channel search server and for editing search properties.

FIGS. 11 and 12 present the client and server communications modules, respectively, based on the TCP/IP protocol.

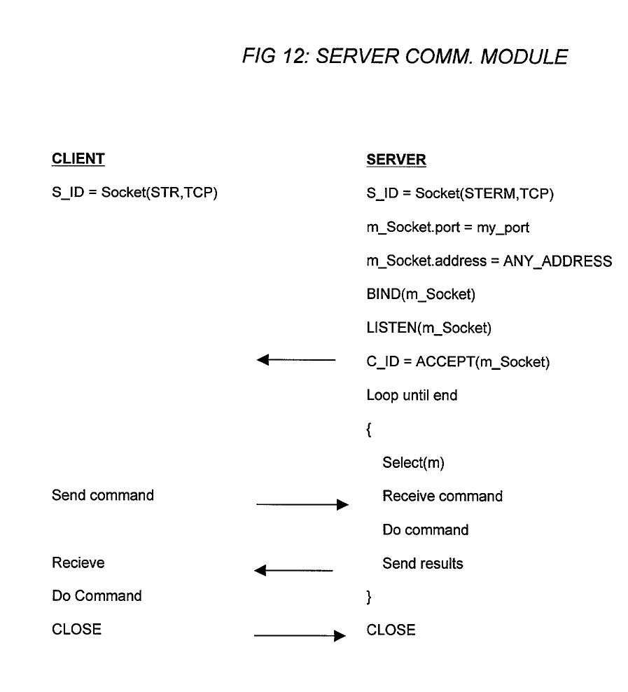

FIG. 13 present the flow of operations in setting a tuner by the client.

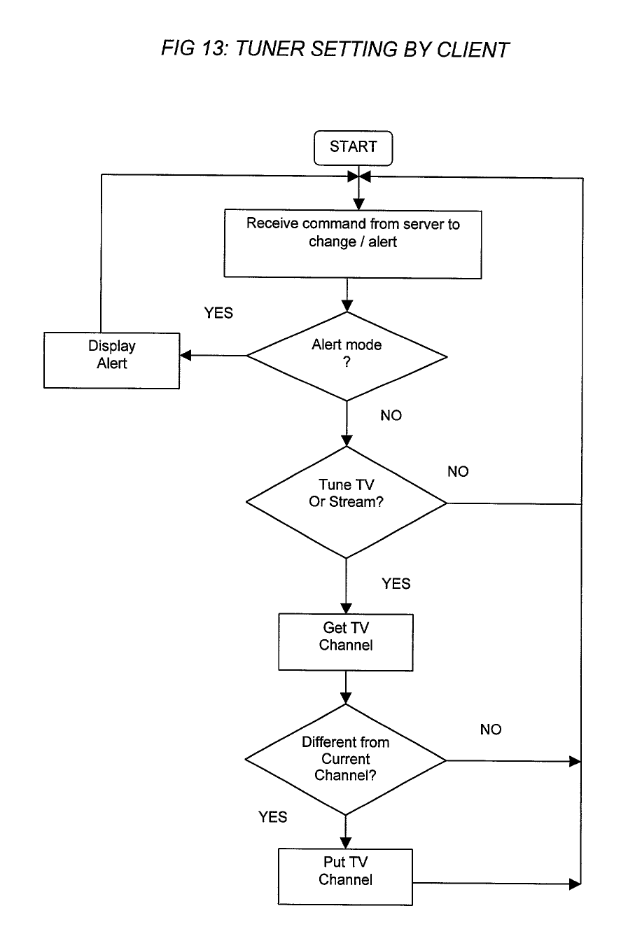

FIG. 14 present a summary flow chart of operation of the system according to the present invention.

### DETAILED DESCRIPTION OF THE PRESENT INVENTION

This invention presents a method of tuning to a channel of interest from a plurality of broadcast signals received by receiver device, using an Internet-enabled computing device.

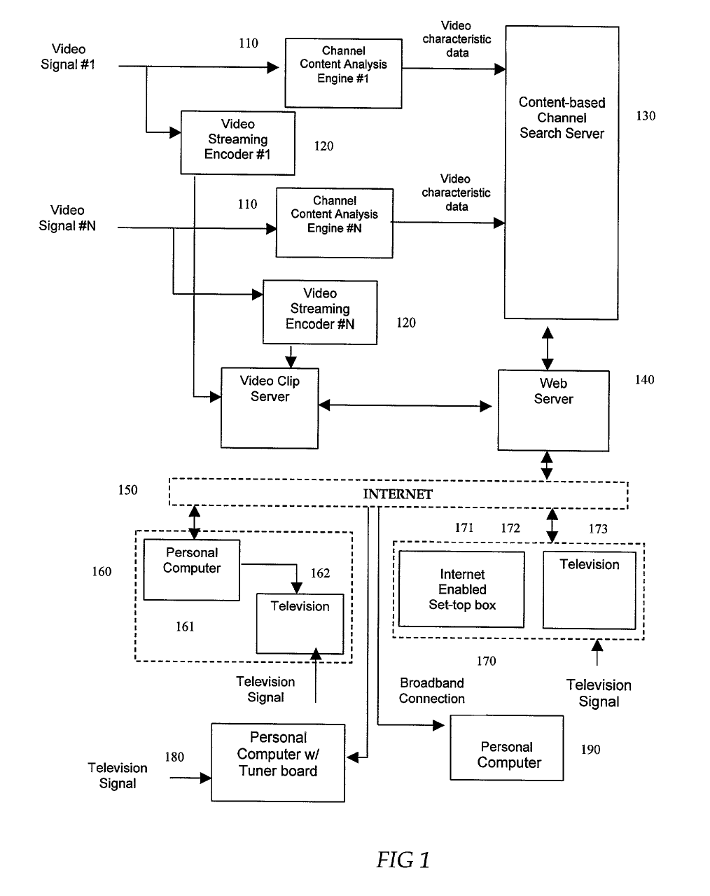

Reference is now made to FIG. 1, which is a block diagram showing an overview of several embodiments according to the present invention. For purposes of simplicity and clarity, the system is described with reference to widely available systems and standards, including conventional analog television receivers and cable-based video networks. It will be appreciated, however, that the particular components of the channel selection system may be implemented with a variety of conventions, standards, or technologies without departing from the underlying concepts of the present invention. The invention is applicable beyond standard television-based systems: for example multimedia, graphics, and animation content. The term “video” is used to describe both an audio-visual content and the image part of that content which consists of a sequence of images and refers also to audio programming only.

All client embodiments depicted in FIG. 1 include at least one broadband or broadcast signal connections for viewing television content and an Internet connection. According to the present invention, Internet services executed by a content-based video search server are used to select preferred channels to be viewed client's display. Client's specific topics, people or general profile of interest are presented as queries to the content-based video search server. Search results are presented on the display device and used, automatically, or based on the user's decision to switch to the channel of interest, record one or more programs, create a log file of events of interest or alert the user.

In 170, a television receiver is integrated with an Internet-enabled set-top box. One existing example is the WebTV box. In 160, a personal computer or another Internet-enabled computing device is connected to the television set. One such connection can be a home local area network (LAN). In 180, a tuner board is installed in the personal computer and allows watching television on the computer display. Multiple such boards are available from vendors such as ATI Technologies Inc. (http://www.ati.com). As another option, tuner devices can be connected to computer via a standard USB port, such as the USB TV! from Nogatech (www.nogatech.com). In 190, video programming and Internet services are delivered to the personal computer via a broadband connection.

According to the present invention, video and audio characteristic data are computed by channel content analysis engine 110 from multiple communication channels and stored in the content-based video search server 130. Said data relate to the content of an audio-visual programs carried by these channels. The term content relates to details such as people, words, objects, sounds and events seen or heard in the video program.

In the case of live programming when no prior knowledge regarding a significant part of the audio-visual content is available, the present invention provides a clear advantage on prior art. When the program is played by the service provide from stored content server, video characteristic data can be computed offline, enhanced manually by attaching text descriptions, synchronized with the video content and stored on the content-based video search server. In such a case, automatic indexing enhances the descriptions and allows searching for people and objects of interest to the viewer but not known to the person preparing the descriptions.

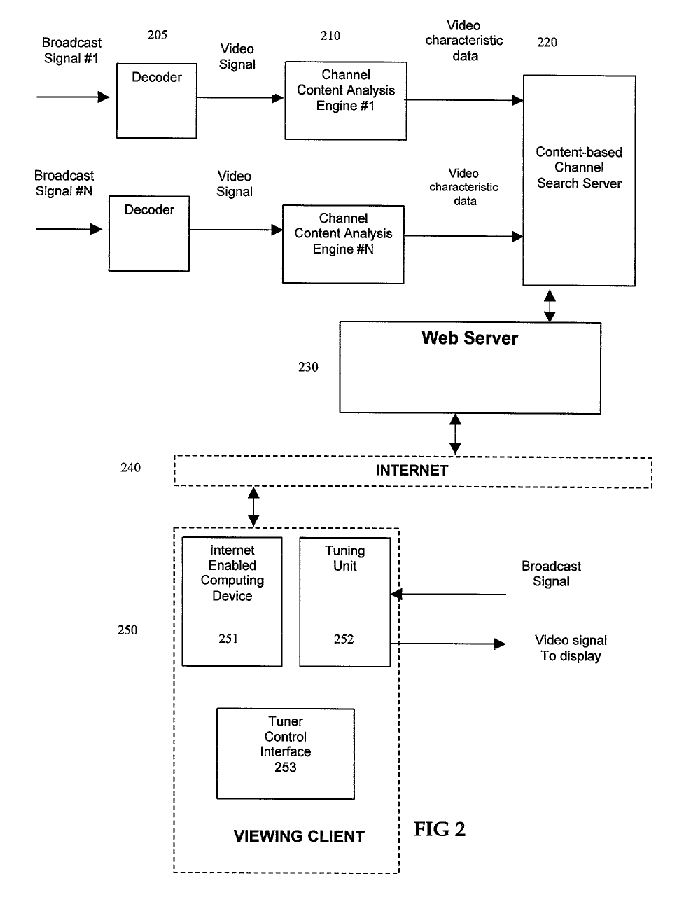

FIG. 2 presents one preferred embodiment according to the present invention. The server and service side arrangement of channel content analysis engines 210; a content-based video search server 220 and web server 230 are as in FIG. 1. Each processing path takes a digital video bit-stream such as an MPEG2 stream, or an analog broadcast signal and decodes the stream or signal in a decoder unit 205, into a sequence of video images. The video feed for each channel may be a live program or a recording on tape. The programming may include standard analog video broadcasts (e.g., NTSC, PAL), digitally encoded video broadcasts (e.g. MPEG), or digital information related to computer-executed applications. Regardless of input format, the bit-stream is converted into a sequence of images and the associated sound track in order to enable analysis of at least one predetermined attribute of the video.

Generally, the server side of the system can be located at the service provider's site. Video analysis can be done for all channels at that site. Alternatively, some global channels such as CNN can be analyzed by a global service provider or by the content originator and distributed to local service providers, where further analysis, related to topics of interest to the local community served may or may not be executed.

The client viewing system 250 comprises of an Internet enabled computing device 251, tuning unit 252 and tuner control interface 253 which uses selected channel indication data from said Internet enabled computing device to control the tuning unit. The tuning unit decodes the video signal from the selected broadcast signal, directing said video signal to a display device. Due to the locality of cable and other content services, a correspondence has to be established between a channel analyzed on the server end and the matching channel received by the viewing client. Creating such a correspondence is generally a first step in installing such a tuner device, where channel 33 for example is matched with CNN Headline News.

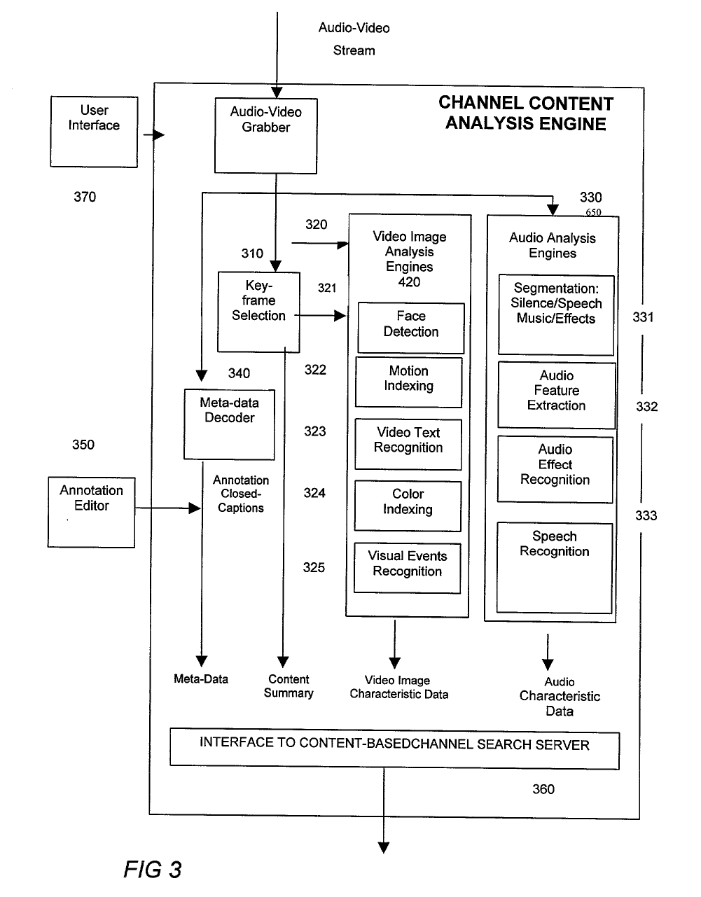

FIG. 3 describes a channel content analysis engine according to the present invention. A key-frame selection module 310 processes the audio-video data stream to produce a content summary. A number of prior-art methods for selecting key-frames are known. Most of them are based on detecting video shot transitions and selecting a frame from each shot (generally the first one) as a key-frame. In the presence of motion, more key-frames have to be selected to represent the content of video including the temporal variation. Application No. PCT/IL99/00169 by the same assignee describes a preferred method of selecting key-frames. In most types of video content, it is sufficient to select only a few percent of the original video frames to get a good representation.

While the summary, which consists of the video key-frames, can be used as a concise descriptor of the video content and provides thumbnails images to be sent to users' terminals as part of the alert or indication of event of interest, more characteristic data should be extracted to allow for efficient automatic channel searching.

Video characteristic data is automatically computed from the video image sequence by video image analysis engines 320. Such engines may include a face detection engine 321; a motion-indexing engine 322, a text image recognition engine 323, a color-indexing engine 324 and a visual events recognition engine 325.

Audio characteristic data is automatically computed from the audio track by audio analysis engines 330. Such engines may include: segmentation to silence, speech, music and effects 331; feature extraction for audio classification 332; and recognition of pre-programmed effects 333.

Certain video streams carry video meta-data such as closed captions, and possibly encoded textual information such as annotations. Meta-data decoder 340 extracts this meta-data, which is added to content-based indexing data. Annotation editor 350 can also add manual annotations. In a live feed situation, the volume of such descriptions is limited due to time constraints. However, they provide additional information about the video content. For prerecorded programs, more detailed text descriptions can be added and used in conjunction with video characteristic data in channel searching.

Prior art methods are known and may be used for implementing each of the above mentioned indexing engines 320-333.

Visual event recognition engine 325 refers to events of interest to certain user communities, which can be recognized from video sequences, with or without further support from the audio track.

Video face characteristic data consists of tracks of face images, obtained by face detection and tracking from the images as described in a patent pending by the same assignee (PCT entitled “METHOD FOR FACE INDEXING FOR EFFICIENT BROWSING AND SEARCHING OF PEOPLE IN VIDEO”).

U.S. Pat. No. 5,828,809 describes a method to detect highlight events such as touchdowns and fumbles in a football game, using both speech detection and video analysis. A speech detection algorithm locates specific words in the audio portion data of the videotape. Locations where the specific words are found are passed to the video analysis algorithm. A range around each of the locations is established. Each range is segmented into shots using a histogram technique. The video analysis algorithm analyzes each segmented range for certain video features using line extraction techniques to identify the event.

As another example, camera flashes can be detection by monitoring the video sequence for abrupt changes in overall luminance. A scene change processor, being a part of the key-frame selection module 310, can detect such changes. As opposed to regular scene changes, the camera flash is of very short duration, after which the regular image content is restored.

Following this example, a camera flash is generally not the term that the average home user will put into his or her search profile. A more likely term of “press conference” in the user profile will be pre-defined at the server location as a query that includes camera flash as a term.

Communication module 360 interfaces the channel content analysis engine to the content-based search server. User interface 370 is a GUI for logging, status and control.

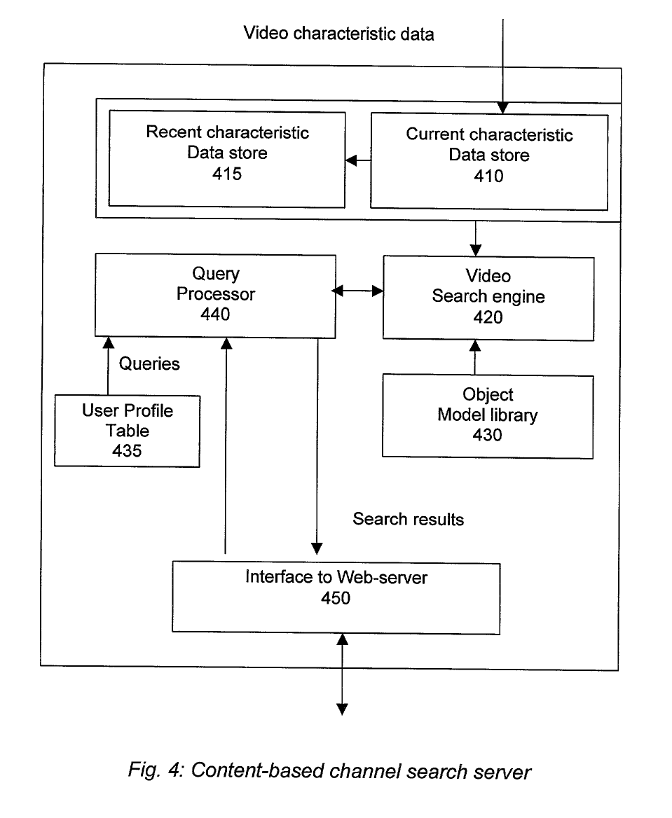

A preferred embodiment for a content-based channel search server is depicted in FIG. 4. The channel search server comprises of the following software components:

Communication to multiple channel search clients

Communication to multiple real-time channel content anslysis engines, for multiple TV channels

Database holding each person preferences, profile and registering information

Database for locations of different streaming channels existing on the internet

GUI for Managing, controlling and logging

Video characteristic data from the analysis engines are stored in the current characteristic data store 410. This store is a buffer, which contains only data related to recent programming (in seconds) being effective for channel searching in live content. Data is then moved to recent data store 415 where for example 24 hours worth of characteristic data can stored to support user queries regarding content delivered recently. By using the recent data store, users can search for recent content of interest. The recent data store may be quite large and can use flat files, a commercial relational database or a proprietary database system.

User profile data are stored as queries and compared every pre-defined time interval with the video and audio characteristic data, corresponding to that interval. A query processor 440 receives a user query, decomposes the query into atomic queries (if necessary) and runs each against stored characteristic data, using the video search engine 420, combining search results and deciding on a match between a query standing for a portion of the user profile and the video content of a specific channel. A user query can be “Press conference on economy” which may be translated into atomic queries including face or voice search of key-people in economy, specific key-words in closed captions or text recognized from speech or from video images and visual events like a camera flash.

The video search engine 420 comprises of several computational modules for specific content attributes (face, text, color, etc), which match a query against characteristic data to detect and report matches. Several methods of the video search engine can be implemented using a text search engine: all text and words decoded from annotations and closed-caption, recognized from speech or from video images, can be searched as text.

Audio and visual event such as laughter, applause, touchdown, camera flash, etc, although recognized by video and audio analysis engines, are stored, once recognized as key-words and a text search engine is used to find them in video characteristic data.

Other characteristic data are stored as signals. These include for example eigen-face vector representations of face images, acoustic features of audio, etc. For such characteristic data, searching is conducted by matching the data with entries in the object model library 430. Such entries may comprise of face models or voice models for query persons.

Queries are generated online by users or by scanning the users profile table and generate the appropriate query for each entry in the profile of every user. The user's profile of interest is matched against the table of current characteristic data. The profile of interest is stored as a set of queries, related to a specific user. A sample user query may include:

Person=Bill_Clinton AND Topic=Economy

Internally, a user query can be further decomposed as follows:

Face=Bill_Clinton OR Voice=Bill_Clinton

In a similar manner, Topic=Economy may be internally related to a set of key-words that can be recognized in speech, decoded from closed-caption, found in annotation or recognized from the video image.

A query may include, in addition to content-based attributes, also atomic text-based attributes such as channel name, type of programming as derived from a program guide table, etc. Example queries are as follows:

Event=Touchdown AND Channel=ESPN

Sound=Laughter AND Genre=Talk show

Since such attributes are stored in advance in the database, the database query engine can combine those attributes with content-based attributes as taught by the present invention.

Due to the large number of possible users, evaluating queries independently for all users, can be inefficient, even if caching techniques are used to re-purpose search results for users with similar profiles. A more efficient implementation analyzes offline the user profiles and creates the union set of atomic queries. Due to the large correlation expected in user profile (due to similar interests and a limited set of choices), that set is significantly smaller. A table of correspondences from query items in the union set to individual users is also created in that offline process. Using that method, in runtime, current characteristic data is compared with the union set only and a true/false flag is set for each term in the set, as related to the content depicted by current characteristic data. After evaluating all the terms in the union set, individual profile evaluation is merely a matter of combining the truth-values from terms that compose the user query.

All characteristic data are stored with a channel ID. Hence, search results are reported with the channel.

According to one preferred embodiment, the content-based channel search server is implemented using the methods of a relational database engine. Database engines can generally handle strings and numbers and can thus support searches on text recognized in video images, automatically transcribed from dialogs and decoded from closed caption. The present invention is described with reference to the Informix Dynamic Server with Universal Data Option (www.informix.com).

According to a preferred embodiment, Datablade technology from Informix is used to search for non-text (signal) items such as face images and sounds. Datablade modules are a set of user-defined types and manipulation functions that are packaged together. The server uses manipulation functions to incorporate and support the needed functionality.

According to another preferred embodiment, the content-based channel search server is connected to the Internet through a web interface module. The Web Datablade Module from Informix provides query capabilities to any web-connected device. Parameters from the user's query or profile are put into the queries, which Informix Dynamic server with Universal Data Option executes, and it then formats the resulting data into HTML for display on a web browser.

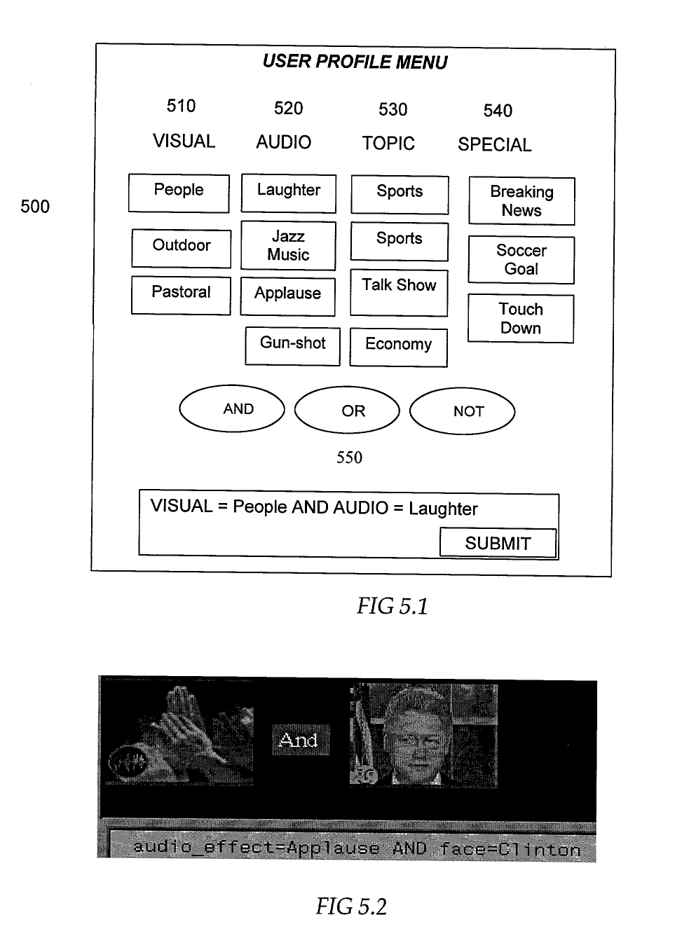

FIG. 5 presents a graphical interface for creating user's queries, according to the present invention. A search menu 500 is overlaid on the user's display. The search menu consists of a set of content-based attributes such as visual attributes 510, audio attributes 520, topic-related attributes 530, and special attributes 540 such as breaking news or explosions. The search menu also includes a simple query language 550 that allows selecting “AND”, “OR” and “NOT” control functions, for generating and displaying, in a display region 550, such queries as: VISUAL=People AND AUDIO=Laughter

Submitting several such queries creates a user's profile of interest. When subscribing to the service described herein, or at any time afterwards, the user may run the profile definition client application. Additionally, pre-compiled user profiles such as “Tennis Fan” can be made available for users to choose from.

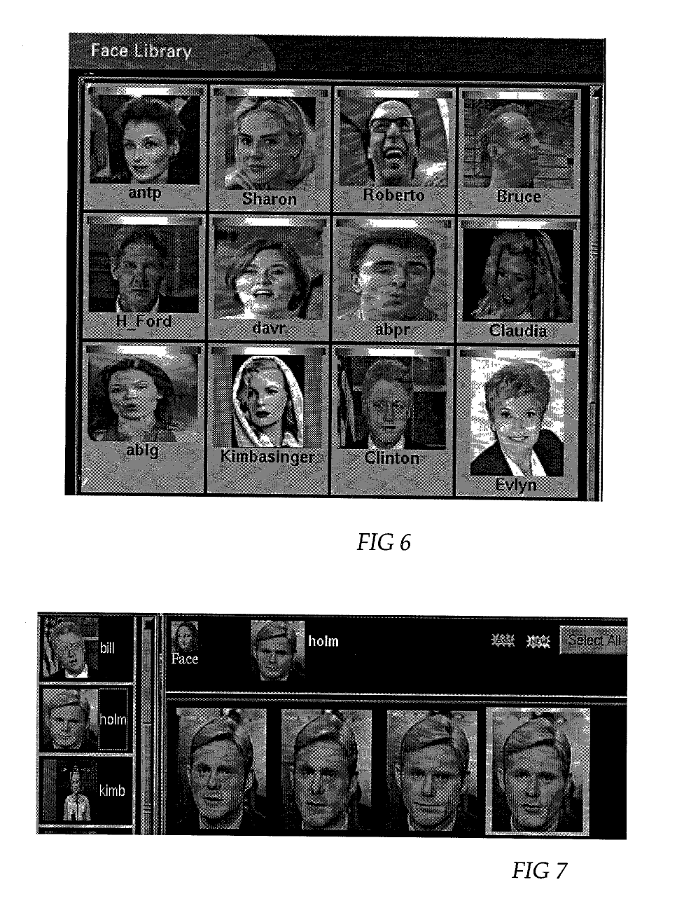

In the people category, further specification is necessary. In one specific case, a user may be interested in a specific Hollywood actor and would like to watch programs that depict that actor. In such a case, the person of interest can be defined by browsing libraries of people in the actors' category, as hosted by the service provider. According to the present invention there is provided a user application for selecting certain people from service provider libraries to include in their interest profile, as described in FIG. 6.

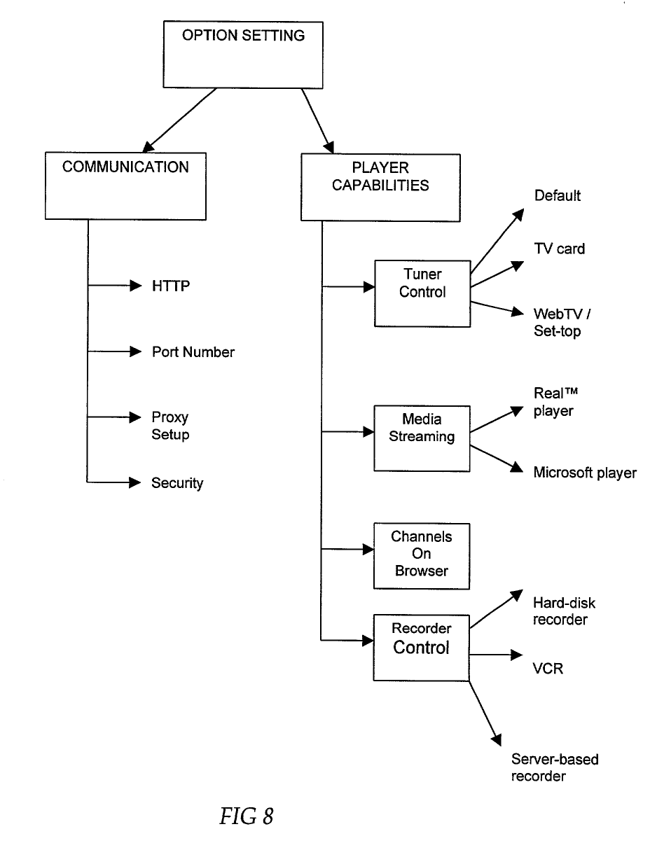

A business user may be interested in a similar service, for people not listed in the public libraries. One such user may be the marketing manager of a large corporation, looking for news items that depict his or her company's chief executive officer. FIG. 7 presents a user interface for enrolling new faces into the face libraries. The interface can be used by the system manager to create public face libraries, or by a privileged user to create a private library. A query is defined by a set of face images depicting the query person. Several images are used to increase robustness of the recognition algorithm to change of viewpoint and expression.

For most types of programming, the time interval of interest is relatively short: on the order of 1-5 seconds. However, the query range is very large: the general categories of Hollywood celebrities may include hundreds of people. Dozens of such categories may be supported. In addition to the selection from pre-compiled libraries of persons, privileged users can create their own personal query. Thus, in a practical situation, short-duration characteristic data is compared with thousands of query items. This is in contrast to the classical query paradigm, where a single query is compared against a large database.

Both paradigms are highly similar. For example, in video face searching, both the characteristic data and the query are represented by a collection of face images or by face characteristic data derived from such images. Therefore, prior art methods related to searching large databases can be used to match against a large collection of queries. According to such methods, the original feature vectors are mapped into a new set of feature vectors in a suitable space, such that a simple distance measure may be used (e.g. Euclidean) while underestimating the actual distance. In addition, distance-preserving transformations are suggested, including the Karhunen Loeve and Discrete Cosine transforms, to represent the original feature vector data with only the first few coefficients for indexing. Transforms such as mentioned above ensure that the resultant vectors will have most of the information (“energy”) in the first few coefficients. Thus, it is possible to apply indexing methods to select a substantially reduced subset of the original records. The retrieval of the results is faster than the sequential search approach, requiring a second phase of post-processing cost to eliminate false hits. The remaining candidates can be matched with the input query at greater care, with more exact distance measures (at greater cost). Existing database management systems use a variety of indexing structures for handling multi-dimensional data. The most successful indexing methods are based on the idea of a balanced, dynamic, multi-way branching tree—such as the B-tree, R-tree, R+-tree and M-tree. R-trees are an extension of B-trees for multi-dimensional objects that are either points or regions.

Furthermore, since atomic queries (such as a known person) are shared across many users, caching techniques as known is prior art can be used to store recently searched items, and retrieve the results directly from search results cache. Alternatively, creating the union set of atomic queries, and going from satisfied queries to related users as described above, can be used.

Search results from comparing current characteristic data against user queries are received from the database engine and delivered to the client side of the respective users. Multiple modes of interaction and display are supported.

In one preferred embodiment, the user is in the “channel surfing” mode of operation. Search results are presented on the user's screen in the form of a thumbnail, channel data and possible indication of the satisfied search criterion. In the case of multiple search results, the results can be ordered by quality. By selecting a search result (clicking on the respective thumbnail), several options can be presented to the user: get more information on the event, view or record.

In a computer environment, said window will appear as a pop-up window on the user's terminal. In a television environment, said window will appear as a picture in picture (PIP) display. Since this mode of operation corresponds to regular television viewing or to a work session, there is provided a control method for reducing possible disturbance when activating this service. The user may limit, via a setup user-interface the number of pop-up windows simultaneously opened by channel search results and in the case of multiple results, display the results with highest score first. Additionally, the user may assign, via a different setup user interface, a priority to each query. Then, in viewing mode, the user may limit reporting search results only to queries of highest priority.

Video viewing can be accomplished on a personal computer display by controlling the tuner to receive the selected channel. Alternatively, the application may select the channel viewed by the user's television display by sending a suitable control signal to the television reception device: tuner or set-top box.

Video program recording can be with any of hard-disk devices provided today by vendors such as Phillips, to a conventional VCR, or on service provider video storage devices. Significant advantages can be offered by server-based recording, such as more efficient allocation of storage resources and handling several concurrent recording commands issued by a single users. A service provider can support such requests in an economical manner: recording all 24 hours of programming and building a personal play-list for each user. Later, the user can consult its personalized, content-based play-list or program guide and select specific clips for browsing.

The present invention can be used in advance to design a personal content-based program schedule. For pre-recorded programs, such as movies, reviews and other, the finished program is available in advance for video indexing. In the case that the content-provider has access to the source material or to the audio-visual characteristic data, the characteristic data can be placed on the server as before and compared with user's profile or queries to generate a personal schedule. The schedule is edited and post-processed to guarantee channel switch before the actual event of interest, to minimize short-duration interruption.

The present invention can be used also after the actual content transmission to surf recent programming in multiple channels. Summaries can be prepared according to the user's profile and presented on his or her browsers. Search results of interest can be investigated in more details by browsing key-frames summaries or playing recorded video from server-based storage.

In a similar session, the user can query the database of recent programming according to topics that are not included in the regular online profile.

According to the present invention, a channel search client resides on the users desktop computer. The client manages and activates the follows software components and tasks:

Communication for The content-based channel search server

GUI for registering and setting user preferences, including setting the criteria for switching to a given channel

Activate and tune a selected channel either by streaming technology or by tuning a TV tuner controlled by software. (Either installed in the desktop or controlled remotely)

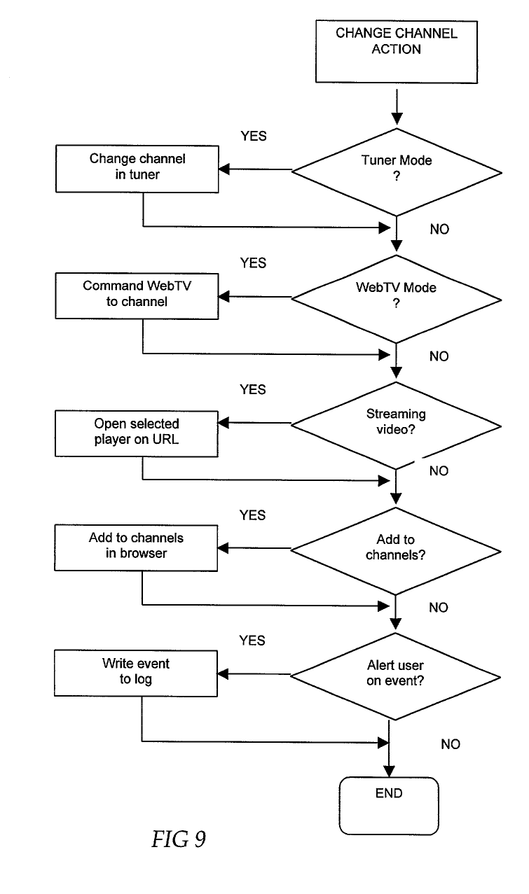

FIG. 8 presents the setting part of the client program. In communication setting the connection is set to port 80 through HTTP or to any port recognized by the Server. In player capabilities setting, the channel streaming/viewing options are determined.

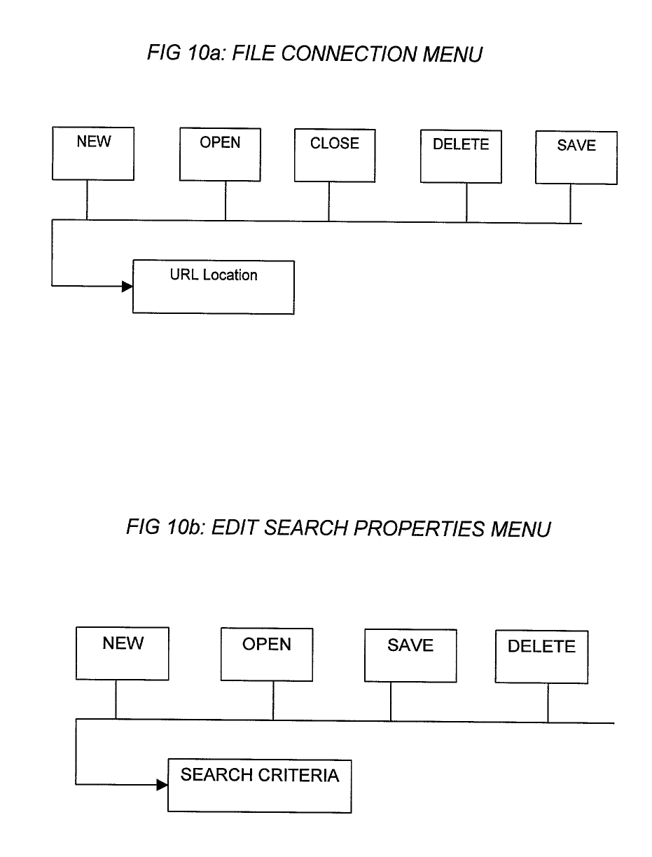

FIG. 9 describes the channel select command on the client side. Possible actions are to set a tuner or to set remotely a device similar to Web-TV set-top box that can receive commands remotely to change its URL and TV channel that are on display: Either a full screen or side by side as in the Picture in Picture feature of TV can be selected. Optionally, the user can view the channel through the Internet, using a suitable video-streaming player (such as Real Or Microsoft Media Streaming Format). A combination of these actions can be controlled. For example, the viewer may want to watch video on his or her computer as a window or in the browser and change a channel in his or her WebTV receiver.

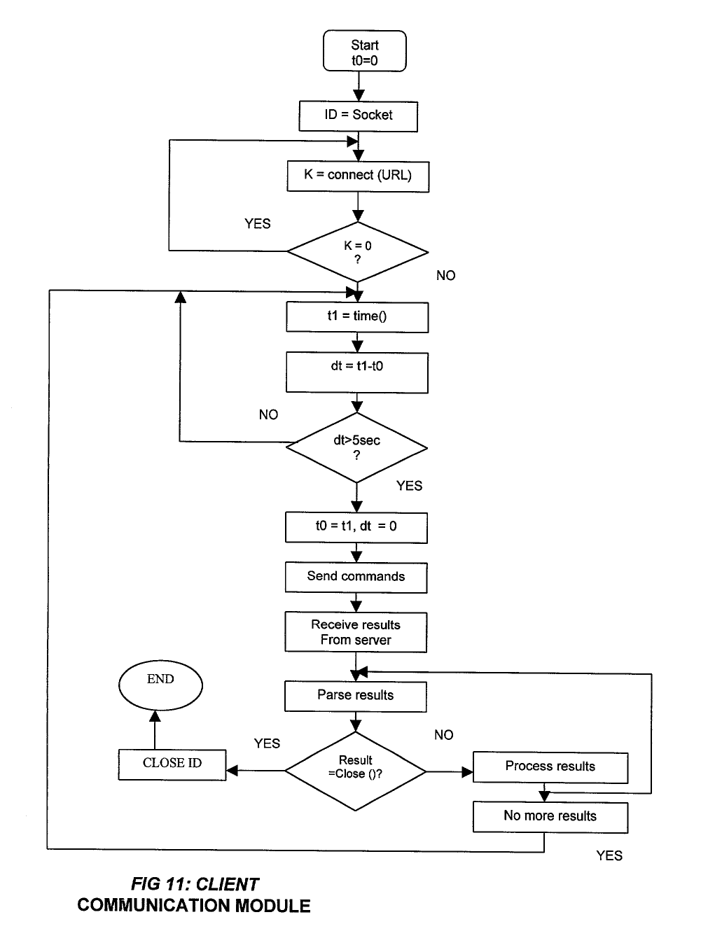

FIGS. 10a and 10b show the flow of actions in the client in respect to channel search service activation and location. The File command enables the creation and management of connections to channel search servers. One or more servers can be used to generate the desired coverage of channels and criteria. For each server, the client connects and then sends and receives commands and results.

On the edit command the user create search properties and send them to the server for processing, or update his or her user profile. Upon execution of the NEW command, a user profile definition menu as presented in FIG. 5 is displayed for the user to define and store new parameters. Several users with different profiles of interest (such as family members) may be using the same channel surfing device.

Diagram 11 and 12 show the flow of the client in respect to the Server. The communication is based on TCP/IP stream based protocol where for each user—client program a process in the server is handling the communication and the authentication and activation of the query from the data-base for a given request. The database on the search Server is continuously updated from new search results on all channels that are in the list of processed channels. Each process of in the server is doing the query from the data=base and send the result to its matching process on the client side (The computer desktop on the other side of the Internet).

The flow of commands in the client matches the progress of the server. The client periodically sends additional requests (in a query mode) and receives an update from the server for its past request. The user can change the period of time for the polling of the server. The server is creating for each new connect request from a client a thread (process) that contain a socketID, accepts the socket connection and waits for either timer or send request from the client for retrieving additional search results. Upon closing the connection from the client the process from the server is closed.

Diagram 13 presents the flow of the tuner setting. According to one preferred embodiment, upon receiving the command from the server, the client either alerts the user or tunes the tuner by special API of Direct-Show By Microsoft Windows. The IAMTVTuner interface contains all the methods for setting and getting the status of the tuner. According to the present invention the following methods implement specific parts of a preferred embodiment:

The get_Channel method retrieves the current TV channel

The put_Channel method sets the required channel based on the current TVFormat and the TuningSpace.

The put_TuningSpace method sets a storage index for regional channel to index mapping

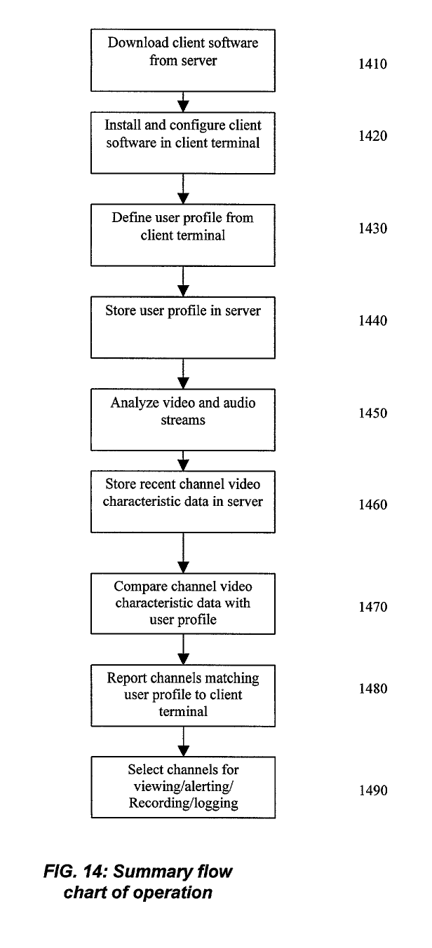

FIG. 14 is a summary flow diagram of preferred steps for selecting a television channel or any video channel based on automatic searching by content.

In initialization steps 1410 and 1420, client software is downloaded from the server, installed and configured in client terminal. In personalization steps 1430 and 1440, user profile is defined on client terminal and stored in server.

During system operation steps 1450 to 1490, currently received video and audio streams are analyzed, and channel characteristic data are stored in the content-based channel search server.

In search step 1470, characteristic data are compared with the user profile. In 1480, channels matching the user profile are reported to current terminal and automatically or based on user choice, channels are selected for viewing, alerting, recording and logging.

While the invention has been described with respect to certain preferred embodiments, it will be appreciated that these are set forth merely for purposes of example, and that many other variations, modifications and applications of the invention may be made.

What is claimed is:

1. A method of selecting a channel of interest from a plurality of communication channels which carry audio or video information, comprising:
extracting image or sound characteristic data from said audio or video information;
searching for specific content of interest based on said image or sound characteristic data;
and selecting a channel based on said content of interest;

2. A method according to claim 1 where said characteristic data is stored on at least one server computer;

3. A method according to claim 1 where said selected channel is displayed on at least one client display;

4. A method according to claim 2 and 3 where client and server communicate via the Internet protocol (IP)

5. A method of tuning to a channel of interest from a plurality of channels received by receiver device, using an Internet-enabled computing device, comprising:
creating a correspondence between broadcast channel signals received by said receiver device and channel characteristic data stored on at least one Internet site;
searching for specific content of interest based on said channel characteristic data;
selecting a channel based on said content of interest;
and tuning said receiver device to said selected channel.
